(19) United States
(12) Patent Application Publication
(10) Pub. No.: US 2009/0044055 A1
(43) Pub. Date: Feb. 12, 2009

(54) METHOD FOR SERVICING HARDWARE OF COMPUTER SYSTEM AND METHOD AND SYSTEM FOR GUIDING TO SOLVE ERRORS

(75) Inventors: Jung-Chung Wang, Taipei (TW); Chia-Mei Hung, Taipei (TW); Chia-Hui Han, Taipei (TW); Jun-Jie Liao, Taipei (TW); Chih-Yi Chen, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/187,382

(22) Filed: Aug. 7, 2008

(30) Foreign Application Priority Data
Aug. 10, 2007 (TW) 96129601

(51) Int. Cl. G06F 11/00

(52) U.S. Cl. 714/27; 714/E11.001

(57) ABSTRACT

A method for guiding to solve system errors is applied to a computer system. The method of the invention includes the step of calling a debugging application software to check a system state of the computer system when a request for detecting errors inputted by a user is received. When a system error occurring in the computer system is detected, a client database is connected to determine whether a corresponding solution for the user to debug the computer system exists. When the solution corresponding to the system error is not searched out from the client database, a network is connected to transfer a detected error message to a client service terminal.

### CROSS-REFERENCE TO RELATED APPLICATION

This application claims the priority benefit of Taiwan application serial no. 96129601, filed on Aug. 10, 2007. The entirety of the above-mentioned patent application is hereby incorporated by reference herein and made a part of this specification.

### BACKGROUND OF THE INVENTION

1. Field of the Invention

The invention relates to a method and a system for guiding to solve errors and, more particularly, to a method and a system for guiding to solve errors for a computer system.

2. Description of the Related Art

When ordinary consumers use electronic products, based on differences of personal usage methods and usage environments, some elements of the electronic products often generate errors or are disabled because of abnormal operation. Every user using electronic products does not have a related profession background. Therefore, when a user operates the electronic products and encounters troubles, he usually does not know how to handle the troubles, which brings great besetment.

Ordinary suppliers supplying the electronic products usually set up client service centers for solving problems that users encounter when they operate the electronic products. However, most encountered hardware problems can be solved by the users without technicians having a special profession background. For example, a condition that a user forgets to connect an electronic product to a network wire causes the electronic product to be incapable of accessing the network. So long as the conditions are sufficiently understood by the users, in fact, the users can solve the problems by themselves.

In a conventional method, when the users operate the electronic products and encounter troubles, they cannot clearly know the conditions. Then, no matter whether the troubles can be solved by the users or not, the users need to contact technicians having a profession background. This not only wastes time of the users but also increases the cost of client service.

### BRIEF SUMMARY OF THE INVENTION

One objective of the invention is to provide a method and a system for guiding to solve system errors for a computer system, and the method and the system can guide a user to eliminate the system errors occurring in the computer system.

Another objective of the invention is to provide a method for servicing a computer system at a client terminal, and the method allows a user to debug by himself without wasting time and cost of repair when a simple system error occurs in the computer system.

The invention provides a method for guiding to solve system errors for a computer system. The method in the invention includes the step of calling a debugging application software to check a system state of the computer system when a request for detecting error inputted by a user is received. When a system error occurring in the computer system is detected, a client database is connected to determine whether a corresponding solution for the user to debug the computer system exists. When the solution corresponding to the system error is not searched out from the client database, a network is connected to send a detected error message to a client service terminal.

The invention provides a method for servicing a computer system at a client terminal, and the method includes the step of providing an operation interface on the computer system at the client terminal to determine whether to check a hardware state of the computer system via application software according to the operation of the client terminal. A client database having a plurality of solutions is provided. In this way, when a system error of the computer system is detected, a corresponding solution is searched for in the client database. When the corresponding solution is searched out from the client database, the searched solution is displayed by the computer system. When the corresponding solution is not searched out from the client database, a connecting method is utilized to transfer a system error message to a client service terminal via a network to enable the client service terminal to guide a user to debug the computer system according to the system error message.

The invention further includes a client service database. After the client service terminal searches out the corresponding solution according to the error message, it can write the solution into the client service database and periodically write data in the client service database into the client database to update data in the client database.

In one embodiment of the invention, the client service terminal may utilize an E-mail or contact modes of other instant messages to guide the user to eliminate the system error of the computer system. The instant message may be a telephone voice or may be realized by instant messaging software on the computer system.

The system error message may be an error code which can be identified by a computer system manufacturer.

The invention further provides a system for guiding to solve hardware errors, and the system is applied to a computer system. The system of the invention includes a client database, an error detecting engine and a client server. The error detecting engine is coupled to the client database, and it determines whether to detect a system state of the computer system according to operation of a user. When the error detecting engine detects a system error of the computer system, a corresponding solution is searched for in the client database. When the error detecting engine searches out the corresponding solution from the client database, the solution is listed for the user in detail. When the error detecting engine does not search out the corresponding solution from the client database, a network is connected to transfer a system error message to the client server. In this way, a client service staff can guide the user to debug the computer system according to the system error message.

In the invention, a solution is searched for in a client database first when an error occurs in a computer system operated by a user. Therefore, when a simple system error of the computer system occurs, the user can be guided to solve the simple system error by himself to save time of repair. In the invention, since the client database can be periodically updated, the cost of client service can effectively decrease.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is block diagram showing a system for guiding to solve system errors of a computer system according to a preferred embodiment of the invention.

FIG. 2 is a flow chart showing a method for guiding to solve system errors of a computer system according to a preferred embodiment of the invention.

### DETAILED DESCRIPTION OF THE EMBODIMENTS

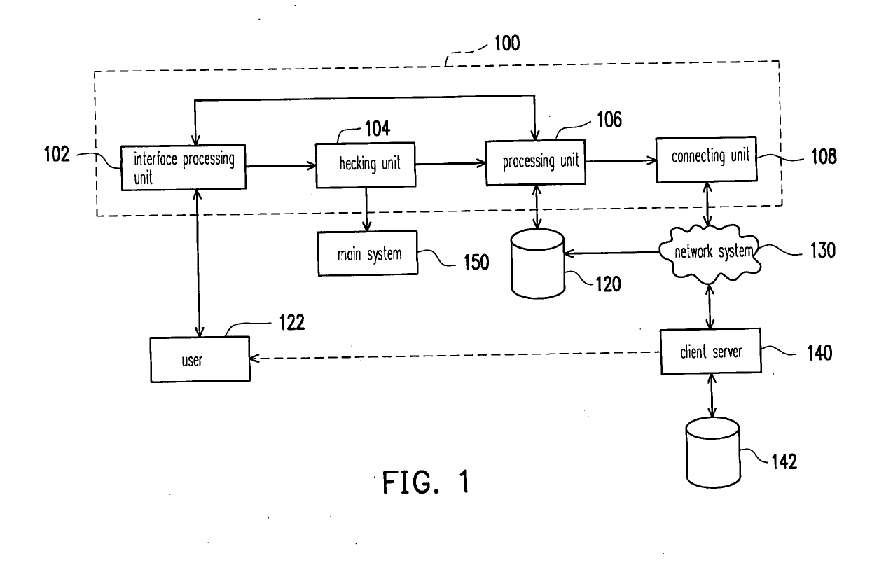

FIG. 1 is block diagram showing a system for guiding to solve system errors according to a preferred embodiment of the invention. As shown in FIG. 1, the system provided by the embodiment is applied to a computer system, and it includes an error detecting engine 100, a client database 120 and a client server 140. The error detecting engine 100 is provided in the computer system at a client terminal and coupled to the client database 120. The error detecting engine 100 may be realized by application software, and it may be coupled to the client server 140 at a client service terminal via a network system 130. In the embodiment, the client database 120 may be provided at the local side of the computer system. In other embodiments, the client database 120 may also be a remote database used by a plurality of client terminals.

In the embodiment, the error detecting engine 100 can provide an operation interface at the computer system for a user 122 to operate. In this way, the error detecting engine 100 can determine whether to detect a hardware state of a main system 150 of the computer system according to the input of the user.

The error detecting engine 100 may include an interface processing unit 102, a checking unit 104, a processing unit 106 and a connecting unit 108. In the embodiment, the interface processing unit 102 can be coupled to the checking unit 104, and the checking unit 104 can be coupled to the processing unit 106. The processing unit 106 can be coupled to the client database 120 and the connecting unit 108. The interface processing unit 102 can provide the user 122 with an operation interface. When the user 122 starts the error detecting engine 100 via the operation interface provided by the interface processing unit 102, the interface processing unit 102 can call the checking unit 104. In this way, the checking unit 104 can detect the hardware of the main system 150 of the computer system according to the input of the user 122.

If the checking unit 104 detects a hardware error of the main system 150, a system error message is sent to the processing unit 106. In the embodiment, the system error message is, for example, an error code predetermined by a computer system manufacturer. When the processing unit 106 receives the system error message, it searches for a corresponding solution in the client database 120. The client database 120 may have a built-in look-up table, and therefore, the processing unit 106 can compare the received system error message with the look-up table in the client database 120 to know whether a corresponding solution exists or not. In the embodiment, the system error includes a hardware error, a software error and an environment setting error of the computer system.

For example, when the checking unit 104 finds that the main system 150 of the computer system has no Internet signal, it sends an error code to the processing unit 106. At this moment, the processing unit 106 can search for a corresponding solution in the client database 120 according to the error code. If in the client database 120, the solution corresponding to no Internet signal is “please check whether a network wire is connected”, the processing unit 106 can send the solution to the interface processing unit 102, and the solution is shown for the user 122. Therefore, the user 122 can check whether the computer system is connected to a network wire according to the shown solution. The above system error is a hardware error.

When the computer system is connected to the network wire by the user, and the checking unit 104 finds that a driving program on the computer system is overdue, it generates another error code to the processing unit 106. Then, the processing unit 106 can search out a corresponding solution such as “please update to a latest driving program” from the client database 120. In this way, the user can solve the software error according to the solution.

When the computer system is connected to the network wire by the user, an error of the software is not found, while the checking unit 104 finds that environment setting such as a domain name server (DNS) is wrong, a corresponding error code is generated and transferred to the processing unit 106. In this way, the processing unit 106 can search for a corresponding solution for debugging for the user from the client database 120 according to the error code. Therefore, the system for guiding to solve errors in the embodiment of the invention can guide the user to solve a simple system error.

If the processing unit 106 does not search out the corresponding solution from the client database 120, it may mean that the system error is an error which cannot be solved by the user. At that moment, the processing unit 106 can call the connecting unit 108 to execute a connecting method. In the embodiment, the connecting method executed by the connecting unit 108 utilizes a wired network or a wireless network to connect to the network system 130 such as the Internet. In this way, the processing unit 106 can transfer the system error message to the client server 140 at the client service terminal via the network system 130.

In other embodiments, if a communication device having a third generation communication function is connected to the computer system, the connecting unit 108 can be connected to the network system 130 such as a third generation communication network via the communication device. Similarly, the processing unit 106 can transfer the system error message to the client server 140 via the third generation communication network.

In the embodiment, the client server 140 can be coupled with a client service database 142. When the client server 140 receives the system error message transferred from the error detecting engine 100 via the network system 130, a client service staff at the client service terminal receives the system error message, and searches for a corresponding solution in the client service database 142. If the corresponding solution is not searched out from the client service database 142, client service staffs having a profession background can research and develop a latest solution according to the system error message and provide the solution for the user 122. In the embodiment, the solution may be provided for the user 122 via an E-mail by the client service terminal.

In other embodiments, the client service terminal can also guide the user 122 to debug the computer system by instant messages. For example, the client service terminal may contact the user 122 via telephone voice or may transfer instant messages to the user 122 via instant messaging software in the computer system or a network telephone to guide the user 122 to debug the computer system.

When the client service staff develops the latest solution, he can write the latest solution to the client service database to save the time of processing the same problem. In other embodiments, the client terminal stores data in the client service database 142 periodically to the client database 120 to update the client database 120. In this way, time and cost for debugging decrease.

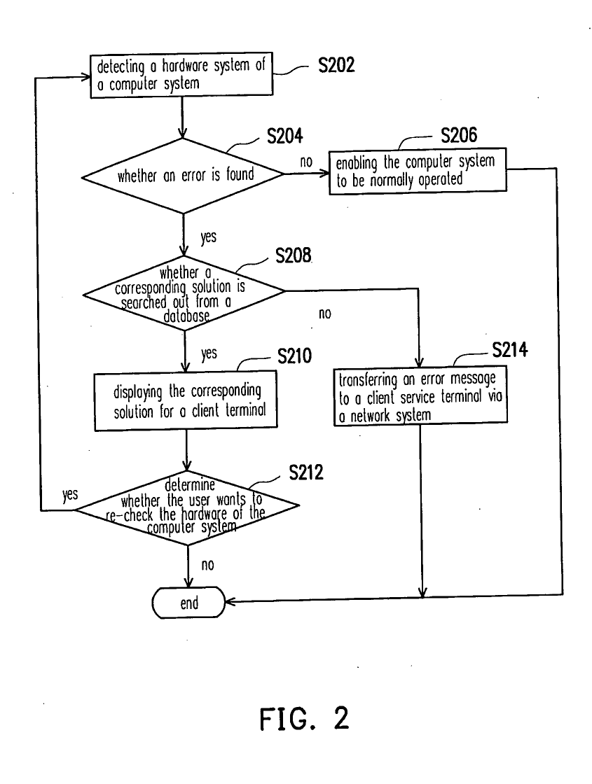

From the above, as shown in FIG. 2, the invention further provides a method for guiding to solve system errors in a computer system. As shown in FIG. 2, in the embodiment, when a detecting request inputted by a user is received, as shown in the step S202, a hardware state of the computer system is detected, and as shown in the step S204, whether an error of the computer system occurs is checked. If no system error is found in the computer system (“no” in the step S204), as shown in the step S206, the computer system is normally operated.

If a system error in the computer system is found (“yes” in the step S204), the step S208 is executed. That is, a corresponding solution is searched for in the client database. If in the step S208, the corresponding solution is searched out (“yes” in the step S208), the step S210 is executed. That is, the solution searched out is shown for the user.

In some embodiments, after the step S210 is executed, the step S212 is executed That is, whether the user needs to re-check the hardware state of the computer system is determined. If yes, the step S202 and so on are repeatedly executed in the embodiment; if no, the method for guiding to solve errors in the embodiment is terminated.

If in the step S208, the corresponding solution is not searched out from the client database of the embodiment (“no” in the step S208), the step S214 is executed. That is, the system error message is transferred to the client service terminal via a network system (such as the Internet or a third generation communication network, etc.). In this way, as shown above, a client service staff at the client service terminal guides the user to debug the computer system according to the transferred system error message.

To sum up, the invention can provide a two stage method for eliminating errors. First, when a solution is searched out from the client database, it is provided for the user to debug by himself. The method for debugging is applied to solve simple system errors in the computer system without contacting client service staffs. Second, when the solution is not searched out from the client database, the client service staff is contacted. Therefore, the invention can save time for debugging and decrease the cost of the client service.

The invention further provides an updating method by which data in the client service database is written into the client database. In this way, when other users encounter the same system error, they do not need to contact the client service staff and can directly debug the computer system via the solution in the client database.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for guiding to solve system errors, which is applied to a computer system, the method comprising the steps of:
calling a debugging application software to check a system state of the computer system when a request for detecting error inputted by a user is received;
connecting to a client database to determine whether a corresponding solution exists when a system error occurring in the computer system is detected; and
connecting to a network to transfer a system error message to a client service terminal when the solution corresponding to the system error is not searched out from the client database.

2. The method according to claim 1 further comprising the steps of:
providing the corresponding solution according to the system error message when the client service terminal receives the system error message;
writing the corresponding solution to a client service database; and
writing data in the client service database to the client database to update the client database.

3. The method according to claim 1 further comprising the step of prompting the user with the solution for eliminating the system error via an E-mail when the client service terminal receives the system error message.

4. The method according to claim 1 further comprising the step of prompting the user with the solution for eliminating the system error via an instant message when the client service terminal receives the system error message.

5. The method according to claim 4, wherein the instant message comprises a telephone voice.

6. The method according to claim 4, wherein the instant message is transferred to the user via instant messaging software.

7. The method according to claim 1, wherein the system error comprises a hardware error, a software error and an environment setting error of the computer system.

8. The method according to claim 1, wherein the system error message comprises an error code.

9. The method according to claim 1, wherein the step of connecting to the network comprises the step of connecting to the Internet via one of a wired network and a wireless network to transfer the system error message to the client service terminal via the Internet.

10. The method according to claim 1, wherein the step of sending the system error message to the client service terminal comprises the step of connecting to a third generation communication network via a communication tool to transfer the system error message to the client service terminal via the third generation communication network.

11. A service method for a computer system at a client terminal comprising the steps of:
providing an operation interface on the computer system at the client terminal to determine whether to check a hardware state of the computer system via application software according to the operation of the client terminal for the computer system;
providing a client database having a plurality of solutions to search for a corresponding solution from the client database when a system error of the computer system is detected;
displaying the solution by the computer system when the corresponding solution is searched out from the client database; and
providing a connecting method for transferring a system error message to a client service terminal via a network to enable the client service terminal to guide the client terminal to eliminate the system error according to the system error message when the corresponding solution is not searched out from the client database.

12. The service method according to claim 11 further comprising the steps of:
providing a solution according to the system error message when the client service terminal receives the system error message; and
providing an updating method for writing the solution to the client database to update the client database.

13. The service method according to claim 11 further comprising the step of providing an E-mail for the client terminal from the client service terminal to guide the client terminal to eliminate the system error according to the system error message.

14. The service method according to claim 11 further comprising the step of providing an instant message for the client terminal from the client service terminal to guide the client terminal to eliminate the system error according to the system error message.

15. The service method according to claim 11, wherein the connecting method comprises the step of connecting to the Internet via one of a wired connecting mode and a wireless connecting mode.

16. The service method according to claim 11, wherein the system error message comprises an error code.

17. A system for guiding to solve system errors, which is applied to a computer system, the system comprising:
a client database;
an error detecting engine which is coupled to the client database and determines whether a system state of the computer system is detected according to operation of a user; and
a client server coupled to a network;
when a system error occurring in the computer system is detected by the error detecting engine, a corresponding solution is searched for in the client database,
when the error detecting engine searches out the corresponding solution from the client database, the solution is listed for the user in detail,
and when the error detecting engine does not search out the corresponding solution from the client database, the network is connected to transfer a system error message to the client server to enable a staff at a client service terminal to guide the user to debug the computer system according to the system error message.

18. The system according to claim 17, wherein the error detecting engine comprises:
an interface processing unit for providing an input interface at the computer system to receive the input of the user;
a checking unit which is coupled to the interface processing unit and is used for determining whether to check the state of the computer system according to the input of the user;
a processing unit coupled to the checking unit and the client database, when a system error of the computer system is found by the checking unit, the corresponding solution is searched for in the client database; and
a connecting unit coupled to the processing unit,
when the processing unit searches out the corresponding solution from the client database, the corresponding solution is transferred to the interface processing unit and is shown for the user by the computer system,
and when the processing unit does not search out the corresponding solution from the client database, the connecting unit is called to be connected to the network to transfer the system error message to the client service terminal.

19. The system according to claim 17 further comprising a client service database which is coupled to the client server and is used for storing the solution provided by the client service terminal, wherein the client service terminal writes data in the client service database to the client database via the client server to update the client database.

20. The system according to claim 17, wherein the network is a wired network, a wireless network or a third generation communication network.
